(19) United States
(12) Patent Application Publication
(10) Pub. No.: US 2015/0053751 A1
(43) Pub. Date: Feb. 26, 2015

(54) Aluminium Composite Material for Fluxless Brazing

(71) Applicants: Kathrin Eckhard, Bonn (DE); Jochen Schwarz, Wassenberg (DE); Olaf Güßgen, Langenfeld (DE); Raimund Sicking, Neukirchen-Vluyn (DE); Hartmut Janssen, Hilden (DE)

(72) Inventors: Kathrin Eckhard, Bonn (DE); Jochen Schwarz, Wassenberg (DE); Olaf Güßgen, Langenfeld (DE); Raimund Sicking, Neukirchen-Vluyn (DE); Hartmut Janssen, Hilden (DE)

(73) Assignee: HYDRO ALUMINIUM ROLLED PRODUCTS GMBH, Grevenbroich (DE)

(21) Appl. No.: 14/531,717

(22) Filed: Nov. 3, 2014

Related U.S. Application Data
(63) Continuation of application No. PCT/EP2013/059290, filed on May 3, 2013.

(30) Foreign Application Priority Data
May 4, 2012 (EP) 12166843.8

(51) Int. Cl. B23K 35/02; B23K 1/00; B23K 35/28

(52) U.S. Cl. CPC B23K 35/0238; B23K 35/288; B23K 1/0012
USPC 228/117; 428/654; 164/76.1; 228/219

(57) ABSTRACT

Use of an aluminium composite material consisting of at least one aluminium core alloy and at least one outer brazing layer consisting of an aluminium brazing alloy provided on one or both sides of the aluminium core alloy. Based on this prior art the object of the present invention is to provide a thermal joining process for an aluminium composite material, so that the use of fluxes can be dispensed with, this object being achieved in that the aluminium brazing layer of the aluminium composite material has a pickled surface and the aluminium composite material is used in a fluxless thermal joining process and the joining process is carried out in the presence of a protective gas.

### CROSS-REFERENCE TO RELATED PATENT APPLICATIONS

This patent application is a continuation of PCT/EP2013/059290, filed on May 3, 2013, which claims priority to European Application No. 12 166 843.8, filed on May 4, 2012, the entire teachings and disclosure of which are incorporated herein by reference thereto.

### FIELD OF THE INVENTION

The present invention relates to the use of an aluminium composite material consisting of at least one aluminium core alloy and at least one outer brazing layer consisting of an aluminium brazing alloy provided on one or both sides of the aluminium core alloy, and the aluminium brazing layer has a pickled surface, a method for the production of a strip aluminium composite material, a method for the thermal joining of structural parts, as well as a brazed construction.

### BACKGROUND OF THE INVENTION

Aluminium composite materials consisting of at least one aluminium core alloy and at least one aluminium brazing layer arranged on one or both sides on the aluminium core alloy are used for producing brazed constructions. Often these have a plurality of brazing joints, as is the case for example with heat exchangers. In this connection various brazing processes are employed for brazing metal structural parts. One of the most common processes is the so-called “Controlled Atmosphere Brazing” (CAB) brazing process, in which the aluminium structural parts are normally brazed using fluxes and are exposed to a precisely controlled atmosphere during the brazing process, for example a nitrogen atmosphere. Other thermal joining processes also use flux and soften the aluminium brazing material also in the presence of a protective gas. However, the use of corrosive or non-corrosive fluxes has disadvantages, for example increased plant costs and technical problems associated with the interaction of flux residues with for example coolant additives in a heat exchanger. In addition the use of chemicals is also problematic in relation to the avoidance of environmental pollution. The second process that is often employed is vacuum brazing, in which the structural parts to be brazed are brazed in an atmosphere at very low pressure, for example about 10⁻⁵ mbar or less. Vacuum brazing can be carried out without flux, though often a certain amount of magnesium is added to the aluminium brazing material in order to obtain a better brazing result. A process for fluxless brazing with the CAB brazing process is moreover known from international Patent application WO 2010/000666 A1, in which the aluminium brazing layer consists of a first aluminium brazing layer and a second aluminium brazing layer. The second aluminium brazing layer consists of an Al—Si aluminium alloy, which in addition to 5 wt. %-20 wt. % silicon also contains 0.01 wt. %-3 wt. % magnesium. The first aluminium brazing layer contains on the other hand 2-14 wt. % silicon and less than 0.4 wt. % magnesium. The two-layer structure of the aluminium brazing layer is disadvantageous, however, in that higher costs are involved in the production of the two-layer aluminium brazing layer.

The use of an alkaline pickled aluminium composite material in a vacuum brazing process or with fluxes in a CAB brazing process is known from Japanese publications JP 04-1000696, JP 04-100674 and also JP 05-154693.

Based on this prior art the object of the present invention is to provide a simple thermal joining method by using an aluminium composite material.

### SUMMARY OF THE INVENTION

The aforementioned object is achieved according to a first teaching of the present invention by using an aluminium composite material with a pickled aluminium brazing layer, characterised in that the aluminium composite material is used in a fluxless, thermal joining process and the joining process takes place in the presence of a protective gas.

It has been found that after an alkaline or acidic pickling of the surface of the aluminium brazing layer the properties of the aluminium composite material in a thermal joining process, in particular a brazing process, in the presence of a protective gas can alter drastically. Thermal joining processes are understood to be processes that heat the aluminium brazing material so that a material closure connection is formed with the connection partner. Normally thermal joining is carried out in the presence of a protective gas, for example an inert gas. In this connection the expression “presence of a protective gas” is understood to mean that at least in the region of the thermal joint seam oxygen is displaced at least partially by the protective gas, so that when the aluminium brazing material fuses the formation of aluminium oxide is prevented or greatly reduced. Up to now, good joining results under protective gas in the case of a simple brazing layer structure could be achieved only by using fluxes. In the use according to the invention good results can also be achieved however without using fluxes.

As a result no flux residues remain on the structural part, which on the one hand saves additional cleaning steps and on the other hand provides advantages in relation to the corrosion resistance of the joined structural parts. In the case of non-corrosive fluxes the advantages of the invention are reflected in particular by the fact that regions of the brazed composite material that subsequently carry media for example do not have any interaction with flux residues.

The aluminium composite material according to the invention can also be used without the use of flux in the CAB brazing process, as comprehensive brazing tests have shown. The pickling leads on the aluminium surface on the one hand to a removal of the aluminium oxide layer that has formed in the production of the aluminium composite material. A new natural oxide layer then forms, which is significantly thinner than the oxide layer formed in the fabrication process of the aluminium composite material. In addition an enrichment of silicon in the surface is achieved by the pickling and the surface is provided with a number of etched depressions. All three effects are considered to be the reason for the very good brazing behaviour of the aluminium composite material according to the invention.

As scanning electron microscopy images show, during intensive pickling, silicon particles can also be exposed on the aluminium brazing layer, so that there is a strong enrichment of silicon directly at the surface. With the use of the aluminium composite material according to the invention, the complex aluminium brazing layer structure known from the prior art, whose object is to permit a fluxless brazing, is not required. A brazed joint can thereby be provided more cost effectively.

According to a further embodiment of the use of the aluminium composite material according to the invention the surface of the aluminium brazing layer is additionally degreased before or during the pickling. The degreasing can be carried out for example by an annealing treatment. However, the use of a degreasing medium is also possible. The degreased surface of the aluminium brazing layer of the aluminium composite material allows an improved pickling attack and thus an improved brazing behaviour without the use of fluxes.

As already mentioned before, according to a next embodiment of the present invention it is advantageous if the pickled surface of the aluminium brazing layer comprises at least partially exposed or exposed silicon particles. Locally higher silicon concentrations occur here, which depending on the brazing material composition can lead to a locally narrower melting range. The silicon particles melt with the surrounding aluminium matrix and to this extent promote the liquefaction of the remaining aluminium brazing material. The wetting properties of the aluminium brazing material are very complex and are still not understood in detail. It has been shown by detailed experiments, however, that at least partially exposed silicon particles can improve the wetting properties of the aluminium brazing material.

According to a further development of the use of the aluminium composite material, an aluminium alloy of the type AA 1xxx, AA 2xxx, AA3xxx, AA 5xxx or AA 6xxx is provided as aluminium core alloy. The aluminium alloy of the aforementioned types as a rule has the mechanical properties that are necessary for the use as heat exchangers, for example, or in other fields of application of brazed constructions. For heat exchangers, aluminium alloys of the type AA 3xxx are particularly preferably used, since these are correspondingly low-alloy materials, are inexpensive and are corrosion resistant.

According to a further embodiment of the use of the aluminium composite material the aluminium brazing alloy has the following composition in wt. %:

### 6.5%≦Si≦15%,

Fe≦1%,

Cu≦0.3%,

Mg≦2.0%,

Mn≦0.15%,

Zn≦0.15%,

Ti≦0.30%,

the remainder being Al and unavoidable impurities individually in an amount of at most 0.05% and totalling at most 0.15%.

As aluminium brazing alloys, for example the aluminium alloys of the type AA 4343 of AA 4045 or AA 4047 are preferably used. Common to all aluminium brazing alloys that satisfy the aforementioned specification is the fact that they have a lower melting point than the aluminium core alloy, so that when the structural part to be brazed is heated to a temperature below the solidus temperature of the core alloy the aluminium brazing layer becomes liquid or partially liquid. The aluminium core alloy does not melt. The Si contents of the aluminium brazing alloy are preferably between 6.5 wt. % and 12 wt. %.

According to a further embodiment of the use of the aluminium composite material according to the invention the composite material is soft, re-annealed or as-rolled before the pickling, so that the mechanical properties, which will be subsequently required during use, are guaranteed.

An aluminium composite material that can be produced economically on a large scale can be provided if the aluminium composite material has been produced by simultaneous casting or roll cladding. As an alternative to simultaneous casting or roll cladding it is also possible to apply the aluminium brazing layer by thermal spraying. The first two mentioned processes are however those that are used industrially on a large scale.

According to a second teaching of the present invention the object stated above is achieved by a method for the production of a strip aluminium composite material consisting of at least one aluminium core alloy and at least one outer aluminium brazing layer provided on one or both sides of the aluminium core alloy, in which a strip aluminium composite material is produced by roll cladding or simultaneous casting followed by rolling, characterised in that the brazing layer of the aluminium composite material is subjected to an alkaline or acidic pickling. As already mentioned before, the inventors have surprisingly found that owing to the alkaline or acidic pickling, the brazing properties, particularly in fluxless brazing, can be significantly improved, so that with CAB brazing the use of a flux can be dispensed with. If the aluminium composite material is degreased with a degreasing medium before the pickling or during the pickling, this leads to an improved pickling removal effect and thus to an improved brazing result. The degreasing before the pickling can also be carried out for example by an annealing treatment. Improved brazing results could be achieved with a degreasing with a degreasing medium during the pickling.

Preferably an alkaline pickling medium contains sodium hydroxide in a concentration of 0.2 to 10 wt. % or 0.2-5 wt. %. It has been found that with the aforementioned concentrations, a sufficient pickling of the surface of the aluminium brazing material aluminium brazing layer can be carried out, so that an aluminium composite material can be provided for fluxless brazing in a simple manner. Apart from sodium hydroxide, an acidic pickling can be employed for example using nitric acid or phosphoric acid for pickling the surface. Preferably the pickling medium contains, apart from sodium hydroxide, also organic or inorganic complexing agents, such as for example sodium gluconate or sodium tripolyphosphate, which surprisingly further improves the brazing result.

The pickling of the aluminium brazing layer preferably takes place in-line with the last cold rolling step, so that a production process that is as economical as possible can be provided. The aluminium composite material can however also be re-annealed or soft annealed in a continuous furnace before the pickling. In this way a coil of a strip brazed composite material optimised for the production of heat exchangers can be provided in an highly economical manner. The use of a coil-to-coil fabrication step that is carried out independently of other production steps is however also conceivable.

Furthermore, the finished rolled aluminium composite material can also be annealed in coil form in a batch furnace and then passed to the surface pickling treatment. These processes too are economically favourable since for example they do not involve high investment costs for continuous furnaces.

According to a further embodiment of the method according to the invention the degreasing medium contains at least 0.2 to 15 wt. %, preferably 0.5-3 wt. % or 2 to 8 wt. % of a mixture of 5-40 wt. % sodium tripolyphosphate, 3-10 wt. % sodium gluconate, 3-8 wt. % non-ionic and anionic surfactants, and optionally 0.5-70 wt. % sodium carbonate, preferably 30-70 wt. % sodium carbonate. The aforementioned composition of the degreasing medium has, particularly in combination with an alkaline pickling that preferably contains sodium hydroxide, led to very good brazing results. The aforementioned degreasing medium can be employed before the application of the pickling treatment or together with the pickling treatment, and leaves a very good brazable surface of the aluminium brazing layer in the CAB process without the use of flux.

In order to prepare the aluminium composite material for subsequent use, it is advantageous if the aluminium composite material is soft annealed or reverse annealed before the pickling. Here the mechanical properties can be adjusted in a simple manner by an annealing process.

Preferably the duration of stay of the aluminium brazing layer of the aluminium composite material in the pickling medium is 1-20 sec., preferably 2-8 sec. This duration of stay allows a sufficient attack of the surface of the aluminium brazing layer by the pickling medium, in order to enrich silicon there or also to expose silicon particles.

The reaction of the pickling medium with the aluminium brazing layer can be further improved if the temperature of the pickling medium is 65° C.-80° C. In particular the process speed can be increased at a higher temperature.

Preferably an acidic rinsing can take place using a nitric acid or sulphuric acid, so that pickling residues can be removed from the strip aluminium composite material.

According to a further teaching of the present invention the object stated above is achieved by a method for the thermal joining of structural parts of an aluminium alloy using an brazed composite material consisting of at least one aluminium core alloy and at least one outer brazing layer consisting of an aluminium brazing alloy provided on one or both sides of the aluminium core alloy, wherein the aluminium brazing alloy has a pickled surface and the aluminium composite material is joined in a fluxless, thermal joining process and the joining process takes place in the presence of a protective gas. Preferred thermal joining processes are brazing under a protective gas or for example the CAB brazing process. Other joining processes requiring a protective gas, such as for example laser brazing, are however also conceivable.

In addition, according to a further teaching of the present invention the stated object is achieved by a brazed construction comprising at least two thermally joined parts, wherein at least one of the parts comprises an aluminium composite material with an aluminium brazing layer, the aluminium brazing layer has a pickled surface, and a thermal joint seam produced in the presence of a protective gas without using a flux is provided between the first part and the second part.

According to a further embodiment of the brazed construction this includes at least one formed or non-formed metal sheet or tube consisting of an aluminium composite material according to the invention.

Such a brazed construction is according to a further development, for example a heat exchanger. The advantages of the brazed construction lie in the fact that the aluminium composite material according to the invention permits a fluxless thermal joining in the presence of a protective gas, for example using the CAB brazing process. By virtue of the fact that no flux residues are any longer present and at the same time no cost-intensive vacuum brazing has to be used, the brazed structural part can be provided with improved durability combined with lower production costs.

### BRIEF DESCRIPTION OF THE DRAWINGS

The invention will be described in more detail hereinafter with the aid of exemplary embodiments in conjunction with the drawings.

FIG. 1 is a perspective representation of an experimental brazing arrangement to establish the brazability of the aluminium composite material.

FIG. 2 is a sectional view along the longitudinal axis of the experimental brazing arrangement of FIG. 1.

FIG. 3 is an experimental brazing result using a conventional aluminium composite material.

FIGS. 4a) to c) show experimental brazing results for three different exemplary embodiments of an aluminium composite material according to the invention.

FIG. 5 is a scanning electron microscopy image on the surface of the aluminium composite material of FIG. 3 before the brazing.

FIG. 6a) to c) are scanning electron microscopy images of the surface of the exemplary embodiments of FIG. 4a) to c) before the brazing.

FIG. 7 is an exemplary embodiment of a brazed construction comprising the aluminium composite material according to the invention.

### DETAILED DESCRIPTION OF THE INVENTION

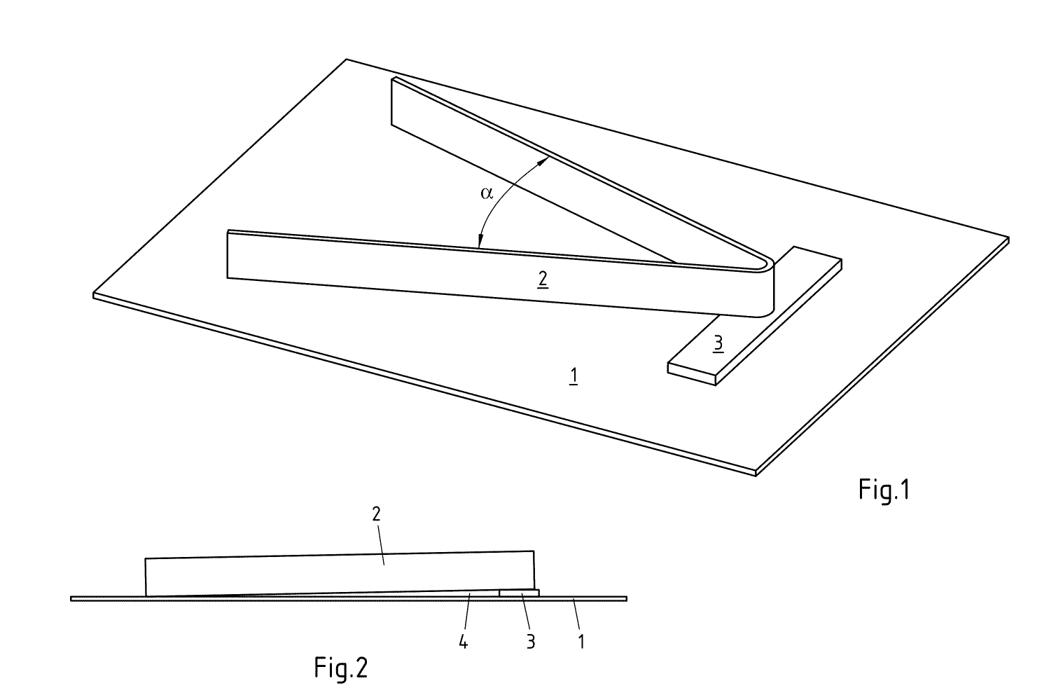

The brazing properties of the aluminium composite material according to the invention were tested using a fluxless CAB brazing process with a specific experimental brazing arrangement as illustrated in FIG. 1. The experimental brazing arrangement consists of a total of three parts, namely a metal sheet 1, an angled metal sheet 2 and a support metal sheet 3 for the angled metal sheet 2. The angled metal sheet 2 lies with its closed end 2a on the support metal sheet 3 arranged on the metal sheet 1. Both branch ends 2b lie however on the metal sheet 1. As is illustrated in a sectional view in FIG. 2, a gap is thus formed that varies from the support point of the branch ends 2b of the angled metal sheet 2 as far as the support point of the closed end 2a on the support metal sheet 3. Owing to the widening brazing gap it is possible to evaluate how good the brazing properties of the metal sheet 1 are. If for example the widening gap 4 is filled to a large extent, it may be assumed that a very good brazing behaviour exists under the specific process parameters.

The metal sheet 1 consists in the present exemplary embodiment of aluminium composite material with a roll cladded aluminium brazing layer. The metal sheet thicknesses used in the experiment were between 0.5 mm and 1 mm. The length of the metal sheet 1 is 70 mm and the width is 50 mm. The length of the branches of the angled piece 2 is in each case 50 mm. The angled metal sheet 2 has an opening angle of 35°. The support metal sheet 3 has a thickness of 1 mm, so that the height difference from the closed end of the angled metal sheet 2 to the branch ends is 1 mm. The thickness of the angled metal sheet 2 is 0.6 mm. The angled metal sheet 2 is not provided with an aluminium brazing layer.

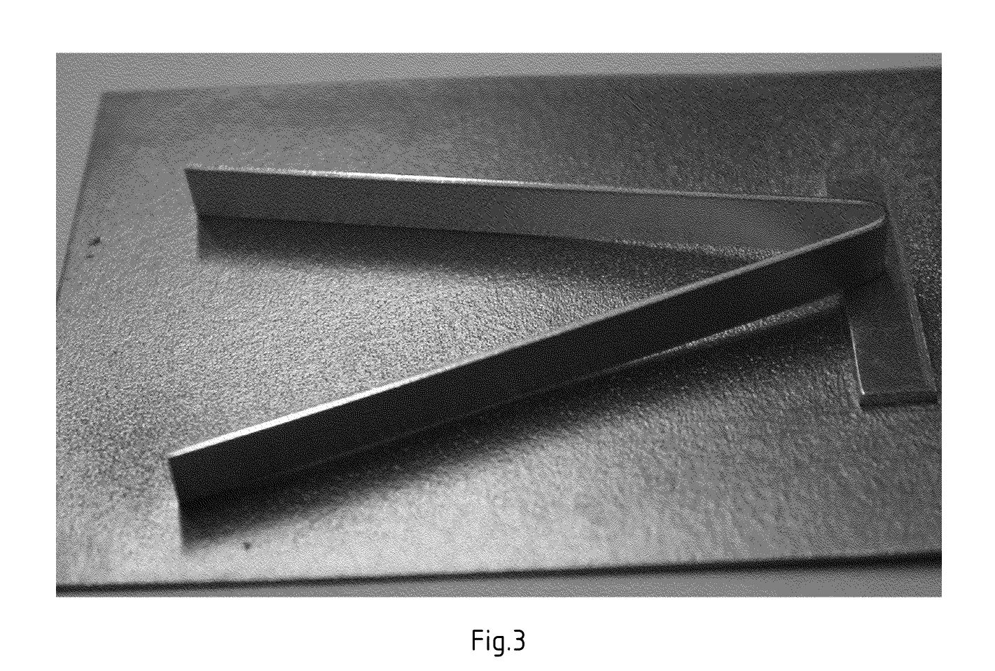

The brazing result of a conventional aluminium composite material is shown in FIG. 3. The aluminium composite material with a core layer of an aluminium alloy of the type AA 3003 had a total thickness of 0.5 mm and was cladded on both sides with an AlSi10-aluminium brazing material (AA 4045). The cladding layer thickness was on each side 11.5% of the total thickness. This resulted in a cladding layer thickness of about 0.0575 mm in each case. The brazing was carried out after a heating phase at a temperature of 600° C., wherein the brazing temperature was held for 4 minutes. The brazing was carried out without any flux in a nitrogen atmosphere. As can be seen from FIG. 3, after the brazing there is no filling of the gap between the angled metal sheet and composite material, so that no brazed joint could be produced. This result was not surprising, since on account of the simple structure of the aluminium composite material a fluxless brazing was not to be expected.

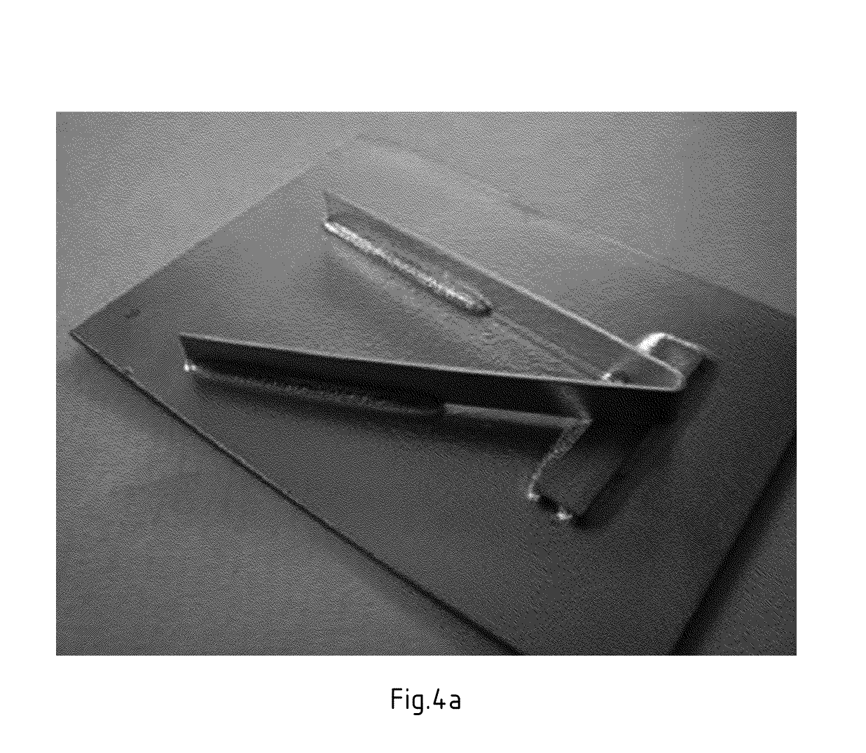

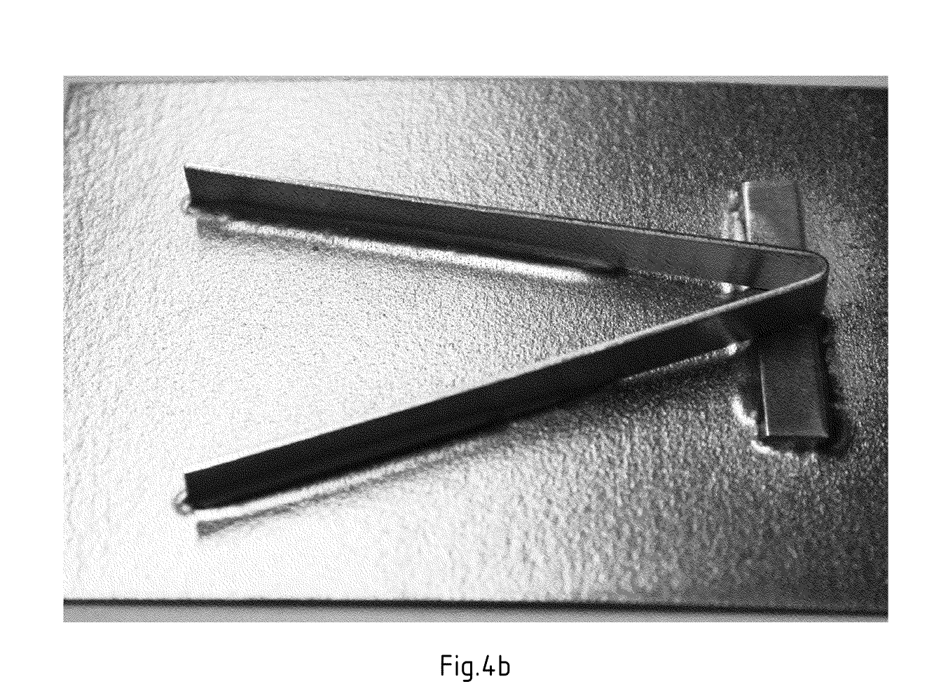

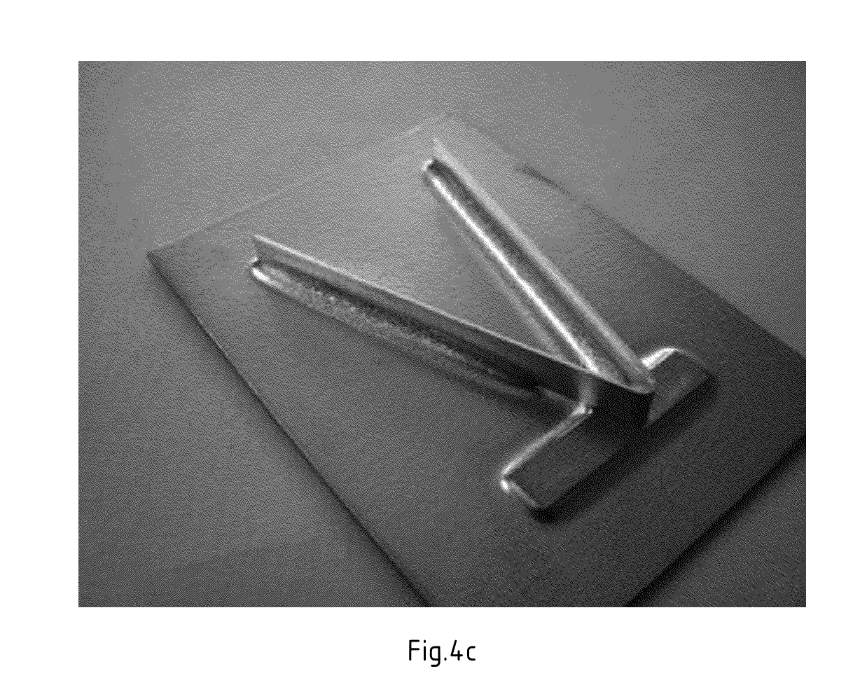

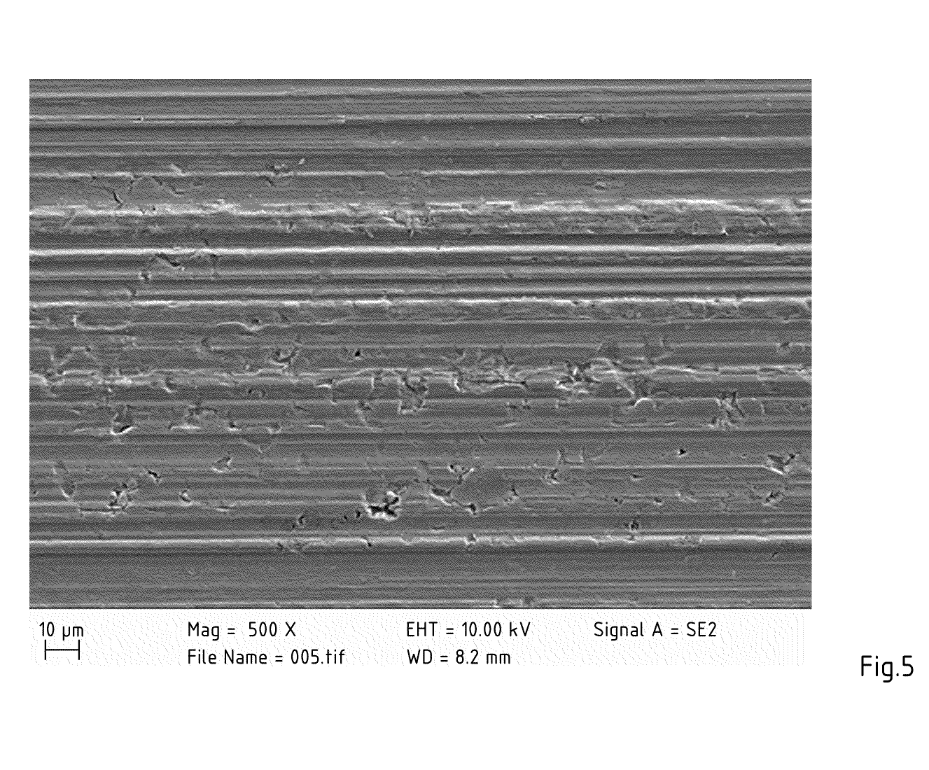

In contrast to this FIGS. 4a) to 4c) show the brazing results using an aluminium composite material according to the invention with a pickled, here alkaline pickled aluminium brazing layer surface. The overall thickness of the employed aluminium composite materials was for the exemplary embodiments illustrated in FIGS. 4a) and 4c) 1 mm with a two-sided cladding layer thickness of 15% or 0.15 mm. The exemplary embodiment of FIG. 4a) was cladded with an AlSi7.5 aluminium brazing layer and the exemplary embodiment of FIG. 4c) with an AlSi12 aluminium brazing layer. An alloy of the type AA 3003 was used as aluminium core alloy. The exemplary embodiment of FIG. 4b) corresponded exactly to that of FIG. 3, with the difference that the exemplary embodiment of FIG. 4b), like also the exemplary embodiments 4a) and 4c) according to the invention, have an alkaline pickled surface.

It is striking to see that the aluminium brazing layer in the region of the support points of the angled metal sheet and moreover along at least about ⅔ of the branch lengths has produced a brazed joint. It can clearly be recognised that the aluminium brazing material present on the aluminium composite material has fused and has produced a brazed joint with the angled metal sheet also in regions with a relatively large gap. Only the regions with an extremely large gap width in the vicinity of the support point of the closed end of the sheet metal angled piece were not brazed. In addition, it can be seen that an improved gap filling is achieved with increasing Si content in the aluminium brazing layer. It is found that with the aluminium composite materials according to the invention with a pickled surface, the use of fluxes can be dispensed with in the CAB brazing process.

The tested aluminium composite materials were roll cladded. Identical results are however also expected for aluminium composite materials produced by simultaneous casting or thermal spraying.

FIG. 5 shows a scanning electron microscopy image of the surface of the exemplary embodiment of a roll cladded, conventional aluminium composite material of FIG. 3, before it was used for the brazing. The illustrated aluminium composite material had been subjected to an annealing treatment in order to bring the aluminium composite material back to the soft state. In FIG. 5 it can clearly be seen that the surface is smooth, contains no silicon particles on the surface, and has a normal rolled structure.

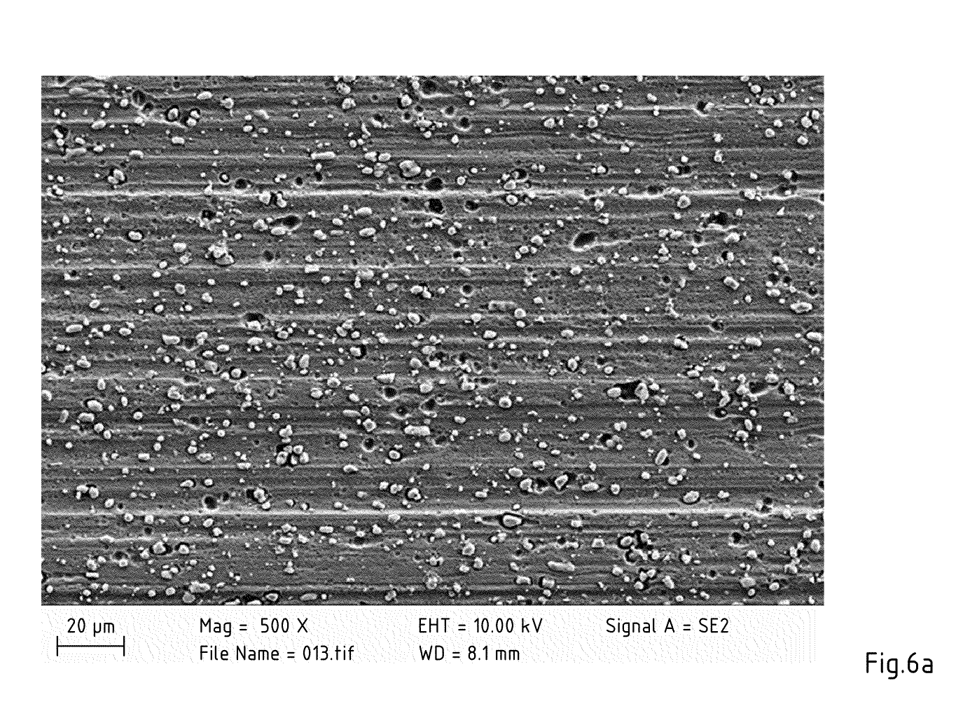

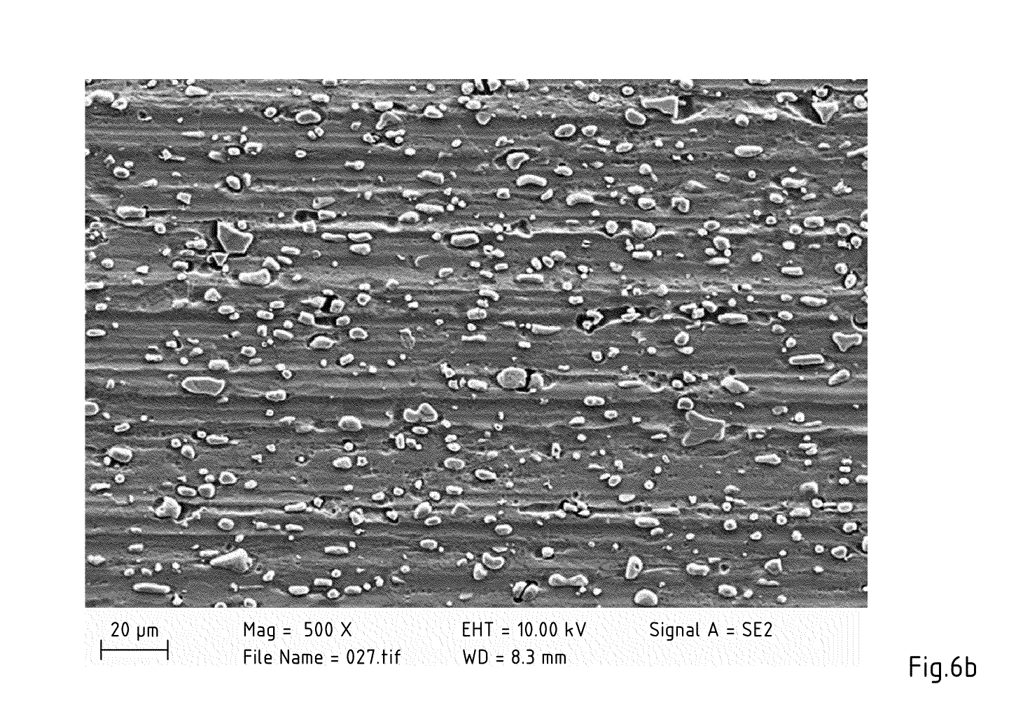

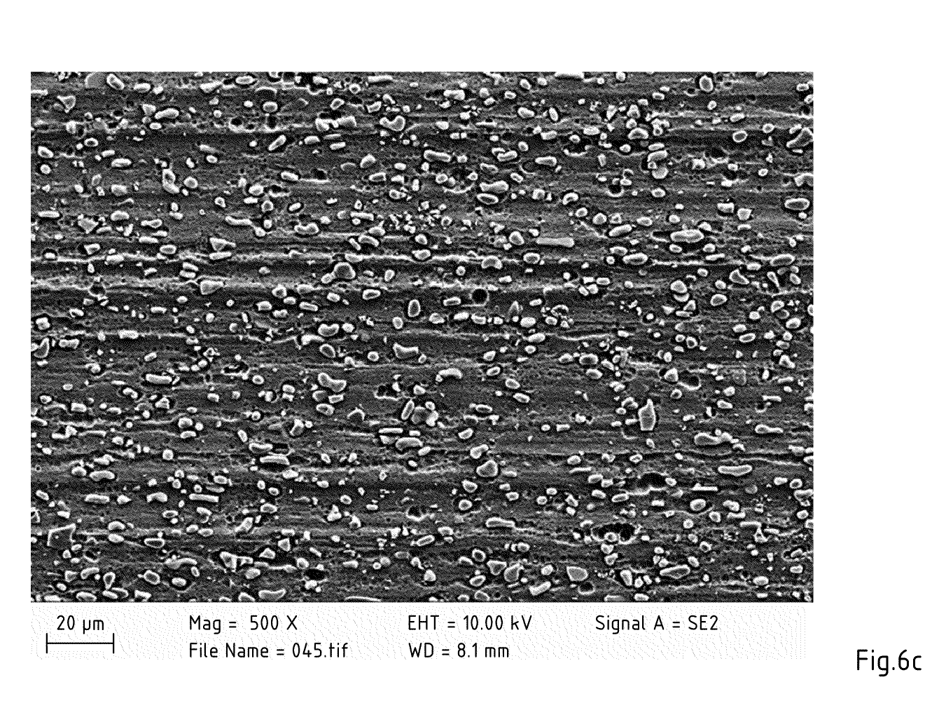

FIGS. 6a) to 6c) show scanning electron microscopy images of the aluminium composite materials of FIGS. 5a) to 5c) after the pickling of the surface. The metal sheets of FIGS. 6a) and 6c) were subjected in the laboratory to a manual pickling by immersion, a sodium hydroxide solution in a concentration of 1 wt. % with a contact time of about 3 minutes at 60° C. pickling temperature being used. The long pickling time was chosen in order to achieve a pickling attack similar to that achieved in fabrication by a spray process. At the same time as the pickling, a degreasing medium was used in a concentration of 1 wt. % of a mixture of 5-40 wt. % sodium tripolyphosphate, 3-10 wt. % sodium gluconate, and 3-8 wt. % of non-ionic and anionic surfactants. After the pickling the composite material was cleaned in a 1% nitric acid solution.

The exemplary embodiment of FIG. 6b) originates from a coil-to-coil production step that at the same time included degreasing and pickling steps and in which the pickling and degreasing medium is sprayed on. In addition to 1.5 wt. % sodium hydroxide solution, the degreasing medium contained 1 wt. % of a mixture of 5-40 wt. % sodium tripolyphosphate, 3-10 wt. % sodium gluconate, and 3-8 wt. % of non-ionic and anionic surfactants. The contact time was 2-8 sec at a pickling temperature of 75° C.

FIG. 6a) shows in comparison to FIG. 5) numerous, at least partially exposed silicon particles and in addition etched depressions on the surface of the aluminium brazing layer. The same is also true of FIG. 6b) and FIG. 6c), wherein on account of the higher Si content of the aluminium brazing layers the occupancy of the surface by at least partially exposed silicon particles rises from FIG. 6a) to FIG. 6c). As is clearly shown on the scanning electron microscopy images, owing to the pickling the aluminium is dissolved in such a way that the silicon particles insoluble in the pickling medium remain on the surface. It is assumed from this that the increase in the silicon concentration in the surface caused by the pickling process leads, for example by means of enrichment up to the exposure of a large number of silicon particles, to the significant improvement of the brazing behaviour of the aluminium composite material. It is also advantageous that the relatively thick aluminium oxide layer present on the surface in FIG. 5, which is formed by the previous process steps, is removed and replaced by a new, very thin aluminium oxide layer. In contrast to FIG. 6a) and FIG. 6c), FIG. 6b) shows fewer deep, etched pits with a relatively large number of at least partially exposed silicon particles on the surface.

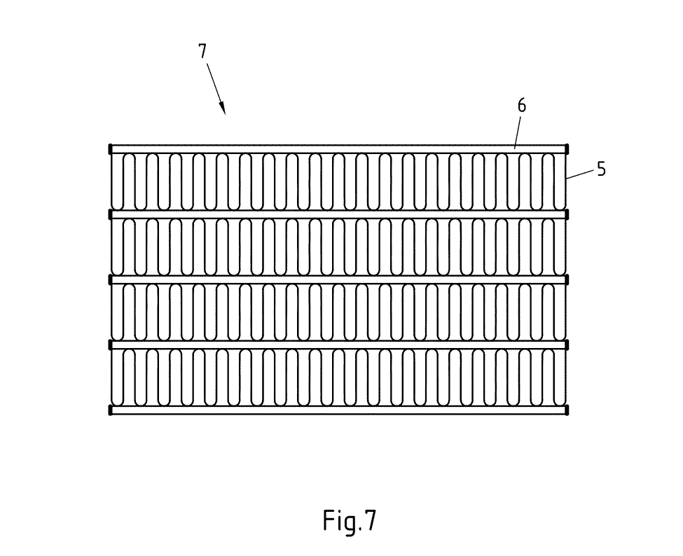

With the aluminium composite material according to the invention it has thus been successful to produce for the first time a brazing in the CAB process with simple aluminium brazing layers and without the use of fluxes. A simple aluminium brazing layer, for example of an aluminium alloy of the type AlSi12, AlSi10 or AlSi7.5, can be used in order to produce brazed constructions with the aluminium composite material according to the invention. For example, the aluminium composite material according to the invention can advantageously be used in the production of a brazed heat exchanger 7, as is illustrated in FIG. 7.

The fins 5 of the heat exchanger consist normally of bare aluminium alloy strip or aluminium alloy strip coated on both sides with an aluminium brazing material. The fins 5 are brazed bent in a meander shape on tubes 6, which means that a large number of brazed joints are required. It is therefore particularly advantageous to use the aluminium composite material according to the invention, since the particularly good brazing results can be achieved in the CAB brazing process also without using flux. The heat exchangers thereby produced have a longer service life if the CAB brazing process is employed, since flux residues are no longer present. The absence of flux residues has a particularly positive effect on the operation of the heat exchangers.

This obviously applies also to other constructions with an aluminium composite material that are normally brazed using flux.

1. An aluminium composite material comprising at least one aluminium core alloy and at least one outer brazing layer and wherein an aluminium brazing alloy is provided on one or both sides of the aluminium core alloy, wherein the aluminium brazing layer has a pickled surface, wherein the pickled surface of the aluminium brazing layer comprises at least partially exposed or exposed silicon particles and the aluminium composite material is configured for joining in a fluxless, thermal joining process, wherein the joining process is carried out in the presence of a protective gas.

2. The composite material according to claim 1, wherein the aluminium composite material is used in a fluxless CAB brazing process.

3. The composite material according to claim 1, wherein the surface of the aluminium brazing layer is degreased before or during the pickling.

4. The composite material according to claim 1, wherein the aluminium core alloy is of the type AA1xxx, AA2xxx, AA3xxx, AA5xxx or AA6xxx.

5. The composite material according to claim 1, wherein the aluminium brazing alloy has the following composition in wt. %:
6.5%≦Si≦15%,
Fe≦1%,
Cu≦0.3%,
Mg≦2.0%,
Mn≦0.15%,
Zn≦0.15%,
Ti≦0.30%,
the remainder being Al and unavoidable impurities individually at most 0.05% and totalling at most 0.15%.

6. The composite material according to claim 1, wherein the aluminium composite material is soft annealed or re-annealed before the pickling.

7. The composite material according to claim 1, wherein the aluminium composite material is produced by simultaneous casting or roll cladding.

8. Method for the production of a strip aluminium composite material according to claim 1, comprising of at least one aluminium core alloy and at least one outer brazing layer consisting of an aluminium brazing alloy provided on one or both sides of the aluminium core alloy, in which a strip aluminium composite material is produced by one of roll cladding or simultaneous casting and subsequent rolling, and the aluminium brazing layer is subjected to an alkaline pickling, wherein the aluminium composite material is degreased with a degreasing medium before the pickling or during the pickling, the degreasing medium containing at least 0.2 to 15 wt. %, 0.5 to 3 wt. % or 2 to 8 wt. % of a mixture of 5-40 wt. % sodium tripolyphosphate, 3-10 wt. % sodium gluconate, 3-8 wt. % of non-ionic and anionic surfactants, and optionally 0.5-70 wt. % sodium carbonate, and the alkaline pickling medium contains sodium hydroxide in a concentration of 0.2 to 10 wt. % or 0.2 to 5 wt. %.

9. Method according to claim 8, wherein the pickling medium contains, in addition to sodium hydroxide, also organic or inorganic complexing agents.

10. Method according to claim 8, wherein a duration of stay of the aluminium alloy strip in the pickling medium is 1 to 20 sec.

11. Method according to claim 8, wherein the temperature of the pickling medium is 65° C. to 80° C.

12. Method according to claim 8, wherein the acidic rinsing is carried out using a nitric acid or a sulphuric acid.

13. Method for the thermal joining of structural parts of an aluminium alloy using an aluminium composite material having at least one aluminium core alloy and at least one outer brazing layer consisting of an aluminium brazing alloy provided on one or both sides of the aluminium core alloy, wherein the aluminium brazing layer has an alkaline pickled surface, the pickled surface of the aluminium brazing layer comprises at least partially exposed or exposed silicon particles, the method comprising joining the aluminium composite material in a fluxless, thermal joining process and wherein the joining process takes place in the presence of a protective gas.

14. Method according to claim 13, wherein at least one formed or non-formed metal sheet or tube is brazed in a fluxless CAB brazing process.

15. Method according to claim 13, wherein a heat exchanger is brazed.

16. Method according to claim 8, wherein sodium carbonate is in a concentration of 30-70 wt. %.

17. Method according to claim 8, wherein a duration of stay of the aluminium alloy strip in the pickling medium is 2-8 sec.
